(19) United States
(12) Patent Application Publication
(10) Pub. No.: US 2017/0176222 A1
(43) Pub. Date: Jun. 22, 2017

(54) LOAD ANGLE MEASUREMENT INSTRUMENT

(71) Applicants: Seyed Mehdi Hosseini Dastjerdi, Qom (IR); Rohollah Abdollahi, oom (IR); Hesam Karrari, Qom (IR)

(72) Inventors: Seyed Mehdi Hosseini Dastjerdi, Qom (IR); Rohollah Abdollahi, oom (IR); Hesam Karrari, Qom (IR)

(21) Appl. No.: 15/452,713

(22) Filed: Mar. 7, 2017

(30) Foreign Application Priority Data
Mar. 7, 2016 (IR) 13945014000301406

(51) Int. Cl. G01D 5/36; H02K 19/26

(52) U.S. Cl. CPC G01D 5/36; H02K 19/26

(57) ABSTRACT

A position of a rotor of a synchronous generator is measured under no load and under load. An angle of difference between where a terminal voltage crosses a zero-point and the marked position of the rotor under no load is calculated. A load angle is of the synchronous generator based the no load angle of difference and the load angle of difference.

### CROSS REFERNCE TO RELATED APPLICATION

This application claims the benefit of priority to an Iran patent application having a serial number 139450140003014064 filed on Mar. 7, 2016, which is incorporated by reference herein in its entirety.

### TECHNICAL FIELD

The present disclosure relates generally to an electrical machine and, in particular, relates to an apparatus and a method for measuring load angle in a synchronous generator.

### BACKGROUND

Generators connected to mains utility supply networks are often synchronous generators. Synchronous generators operate by rotating a set of magnets attached to a rotor within a set of fixed windings. The structure supporting the fixed windings is generally termed a “stator,” and its windings can be termed “stator windings.” The rotor magnets can be permanent magnets or can be electromagnetic devices, termed “rotor windings,” that are energized by a direct current (DC) received from an “exciter.” Rotating the rotor, e.g., by an internal combustion engine or steam turbine, induce, causes a sinusoidal changing of a magnetic flux through the stator windings, due to the movement of the rotor magnets. The sinusoidal changing flux induces a sinusoidal voltage in the each of the stator windings. If a load is connected to a stator winding the sinusoidal voltage urges a sinusoidal or alternating current (AC) through the stator windings and their attached load.

For purposes of this description, synchronous generators having rotor windings fed by exciter currents are termed “exciter-driven synchronous generators.” It will be understood that exciter-driven synchronous generators can, but do not necessarily include additional permanent magnets.

Exciter-driven synchronous generators generally employ control of the exciter current, to maintain a constant generator output voltage regardless of change in the attached load. More specifically, exciter current sets the electromagnetic flux passing from the rotor windings and through the stator windings. This, in turn, sets the voltage level induced in the stator windings, which, if no load is attached, is the generator output voltage. If a load is attached, and the exciter current is unchanged, there can be a reduction in generator output voltage, for reasons including internal resistive losses. One technique for controlling exciter current is to detect the generator output voltage, then increase the exciter current if the voltage drops below the target, and decrease the exciter current if the output voltage exceeds the target.

In addition to variation in output voltage, effects of no control or insufficient responsiveness of control exciter current can include “over-excited” or “under-excited” rotor windings. Secondary effects of over-excited and under-excited rotor windings can include the generator operating in the network as a reactive load.

A technical problem exists, though, in responsiveness of existing exciter current control techniques. This technical problem can have significant costs because changing load can cause sudden step changes in the network voltage, which in tum can result in the exciter-driven synchronous generator being transiently over-excited or under-excited. This state continues until the exciter control system has corrected for the change. However, present techniques for exciter current control can have significant delays and corresponding lack of responsiveness, for example, due to inertia in the system. For example, a time constant of a rotor in synchronous generators above 1000 kVA may be in the order of seconds.

One example cost that can arise from this existing technical problem of under-responsive exciter current control can include an under-excitement condition due to a step increase in loading, with the condition having a severity and duration causing the rotor to start to “pole slip,” thereby rendering the generator inoperative. Other example costs are described in greater detail later in this disclosure.

There is therefore a need for a responsive, low cost technique for exciter current control, and an included need for responsive, low cost techniques for measuring certain generator and network states.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Systems and methods calculating load angle are described. Disclosed methods include measuring a rotor position under no load and obtaining a resulting measured rotor position of the rotor under no load, providing to a processor the measured rotor position of the rotor under no load and calculating, at the processor, a no load angle of difference. The no load angle of difference, in an aspect, can be calculated as an angle of difference between where a terminal voltage of a synchronous generator crosses a zero-point and the measured position of rotor under no load.

Disclosed methods can further include calculating, at the processor, a load angle of difference, the load angle of difference being an angle of difference between where a terminal voltage of a synchronous generator crosses a zero-point and the measured position of the rotor, when the rotor is under load. Disclosed aspects include calculating the load angle of the synchronous generator based on no load angle of difference and the load angle of difference.

### BRIEF DESCRIPTION OF THE DRAWINGS

Features of the subject technology are set forth in the appended claims. However, for purpose of explanation, several implementations of the subject technology are set forth in the following figure.

FIG. 1 illustrates a block diagram representing one example flow in one process of measuring load angle that is provided by one or more implementations of systems and methods according to the present disclosure;

FIG. 2 illustrates an implementation of a load angle measurement process provided by one or more implementations of systems and methods according to the present disclosure;

FIG. 3 illustrates a block diagram of an example implementation of one load angle measurement system providing for one or more processes in methods according to the present disclosure;

FIG. 4 illustrates example calculated values of active power, reactive power and voltage, provided by example processes in practices of methods and systems according to the present disclosure;

FIG. 5 illustrates results of measured load angles one example operating synchronous generator, over an illustrated time span, using measurement and calculation processes provided in practices of methods and systems according to the present disclosure;

FIG. 6 illustrates results of estimation of load angle, and accompanying measurement of load angle, in an example operating synchronous generator, feeding a grid, over an illustrated timeline in testing practices of methods and systems according to the present disclosure;

FIG. 7 illustrates comparisons of estimated load angle to measured load angle for a synchronous generator, in response to changing loads, over an illustrated time span, using estimations and measurements provided by methods and systems according to the present disclosure;

FIG. 8 illustrates comparisons of estimated load angle to measured load angle for a synchronous generator, in response to other changing loads, over another illustrated time span, using estimations and measurements provided by methods and systems according to the present disclosure; and

FIG. 9 illustrates comparisons of estimated load angle to measured load angle for a synchronous generator, in response to other changing loads, over another illustrated time span, using estimations and measurements provided by methods and systems according to the present disclosure.

### DETAILED DESCRIPTION

In the following detailed description, various examples are presented to provide a thorough understanding of inventive concepts, and various aspects thereof. However, upon reading the present disclosure, it may become apparent to persons of skill that various inventive concepts and aspects thereof may be practiced without one or more details shown in the examples. In other instances, well known procedures, operations and materials have been described at a relatively high-level, without detail, to avoid unnecessarily obscuring description of inventive concepts and aspects thereof.

A synchronous generator includes a rotor supported by bearings, to be rotatable within a fixed stator that supports plurality of particularly arranged and orientated windings, which can be termed “stator windings.” The rotor can support magnets, either permanent magnets or electromagnets, that form one or more N-S pole pairs. For purposes of this description, it is assumed the magnetics include one or more electromagnet devices, which will be termed “rotor windings,” The rotor windings are generally configured such that rotation of the rotor rotates the N poles and S poles to sweep a circular trace within and spaced inward from the stator windings. The stator windings are arranged such that the N-S poles sweeping past causes an oscillating magnetic flux through the windings that the induces, in each, a stator voltage that oscillates in a sinusoidal manner. The frequency of the sinusoidal voltage, in cycles per second, is equal to the number of N-S pole pairs per second that sweep past each stator winding directly, which is directly proportional to the rotational speed of the rotor, a speed that can be measured in revolutions per minute (RPM), or angular speed.

Assuming each stator coil is connected to a load to form a circuit, the stator voltage urges a current through each of the circuits. The magnitude of the current, assuming the load does not cause the generator to saturate, is approximately equal the stator voltage, i.e., the voltage induced across the stator coils by the moving rotor poles, divided by the load resistance. The current can be termed “armature current” “stator current, and causes the armature windings to create corresponding magnetic fields, that can spatially sum to a rotating “stator field.”

The perpendicular component of the stator field interacts with the rotor fields such that the prime mover, e.g., an internal combustion engine or steam turbine, must apply a drive torque to maintain the rotor speed. The parallel component of the affects the voltage appearing on the stator windings. The load that is connected to and supplied by the generator determines the generator voltage, for reasons including resistive losses that are proportional to stator winding current. If the load is inductive, the angle between the rotor field and stator fields will be greater than 90 degrees, and this corresponds to an increased generator voltage. This is known as an overexcited generator. The opposite is true for a generator supplying a capacitive load, which is known as an under-excited generator.

Synchronous generators can include, as one arrangement of stator windings, a set of three “phase windings” that are spaced 120 degrees apart. It will be understood that three is not a limit, and was selected as an example only because three-phase windings are relatively common. The three phase windings can connect to and supply three transmission lines, such that in operation the synchronous generator provides a three phase power circuit.

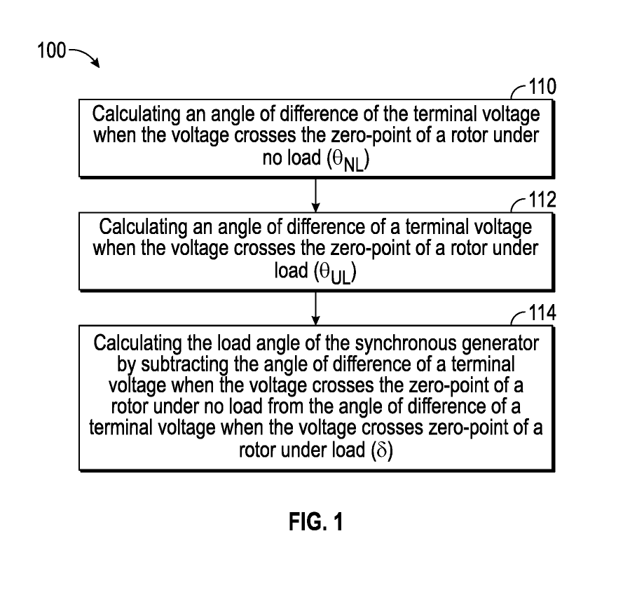

FIG. 1 illustrates a block diagram 100 representing one example flow in one process of measuring load angle that is provided by one or more implementations of systems and methods according to the present disclosure. An example flow of operations in performing one process of measuring load angle according to this disclosure will be described in reference to the block diagram 100. The operations will be collectively referenced the “flow 100.”

FIG. 1 shows a first block 110, and exemplary operations in the flow 100 applied at 110 can include calculating an angle of difference under no load (θ_{NL}) between a reference time corresponding to a rotational position of the rotor and where the terminal voltage crosses a zero-point. For purposes of description θ_{NL} can be termed a “no load angle of difference.” A second block 112 can include operations of calculating an angle of difference under load (θ_{UL}) between what can be the same rotational position of the rotor and where the terminal voltage crosses a zero-point. For purposes of description θ_{UL} can be termed a “load angle of difference.” A third block 114 can include operations of calculating the load angle (δ) of the synchronous generator by subtracting the no load angle of difference θ_{NL} (determined at first block 110) from the load angle of difference θ_{NL} (determined at second block 112).

Referring to the first block 110, one example of calculating θ_{NL} can be based on a measuring, via a sensor such as described in greater detail later, a position of the rotor under no load. The sensor may be configured, for example, to measure the position of the rotor as well as the time intervals that a marked point on the rotor, under no load, passes by a sensor reference position. The measured position of the rotor under no load may be sent from the sensor to a processor, and the processor can then calculate the no load angle of difference θ_{NL}, i.e., the angle of difference between where the terminal voltage crosses a zero-point and the position of the rotor, when the generator is under no load.

In the second block 112, one example of calculating θ_{UL} can be based on a measuring, via a sensor such as referenced above, a position of the rotor under load. The sensor may be configured, for example, to measure the position that a marked point on the rotor under load passes by the above-described sensor reference position. The measured position of the rotor under load may be sent from the sensor to the processor. The processor can then calculate the load angle of difference θ_{UL}, i.e., the angle of difference between where the terminal voltage crosses a zero-point and position of the rotor, when the generator is under load.

In the third block 114, the load angle of the synchronous generator can be calculated by subtracting θ_{NL} from θ_{UL}.

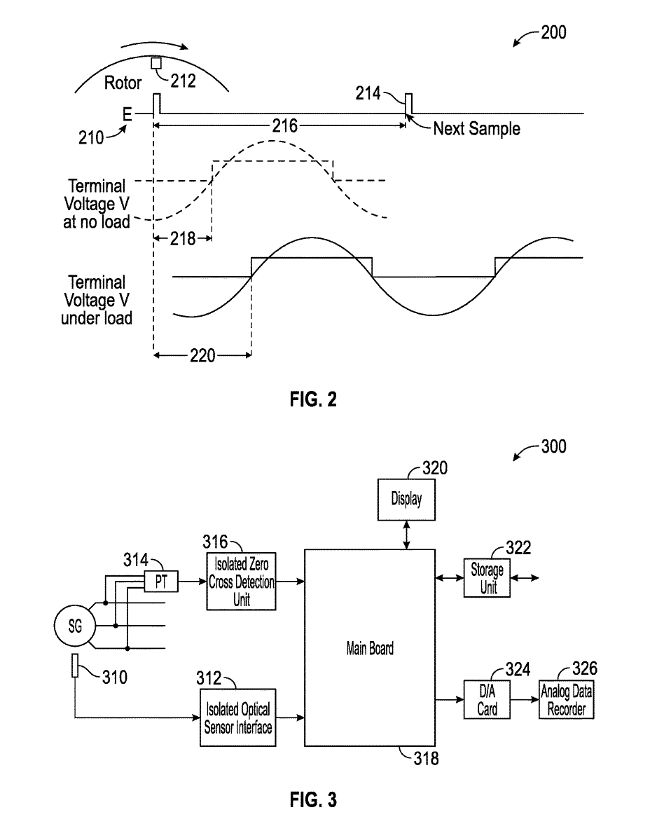

FIG. 2 illustrates an implementation of a load angle measurement process (“measurement process”) 200 to perform the above-described measurements and calculation of θ_{UL} and θ_{UL}. The measurement process 200 may include: measurement of a rotor position 210, based on a marked point or index 212 on the rotor, a sensor pulse 214, measurement of a zero-cross of the terminal voltage 216 under no load, measurement of a difference of the rotor position and the zero-cross of the terminal voltage under no load (“no load”) 218, and a measurement of the difference of the rotor position and the zero-cross of the terminal voltage under load (“under load”) 220. An example system for performing the above-described measurements and calculations is described in greater detail in reference to FIG. 3.

In an implementation a sensor, such as the example illustrated in FIG. 3, can be configured to measure the rotor position 210. A marked point on the rotor (index 212) may be used as a reference for measuring the rotation position of the rotor under no load 218 and under load 220. The sensor may sense and send a sensor pulse 214 to a processor, such as the example processor illustrated in FIG. 3, each time the index 212 passes across the sensor. The sensor pulse 214 may be equal to the rotation period of the terminal voltage 216. The rotation period of the terminal voltage 216 is proportional to the inverse of the frequency of the terminal voltage, as shown in Equation (1) below:

T=1/f Equation (1)

where T is the rotation period of the terminal voltage 216 and f is the frequency of the terminal voltage.

Upon measuring the no load rotational period and the loaded rotational period, as described above, θ_{NL} can be calculated applying, for example, Equation (2) below.

θ_{NL}=T_{NL}/T×360 Equation (2)

where T_{NL} is the time difference between the rotor position pulse 214 and zero-cross of terminal voltage under no load 218. TNL 218 may be measured, for example, when the generator is not connected to the grid. The measured ONL may be stored in a storage unit, such as the example storage unit described in reference to FIG. 3. Upon measuring the θ_{NL}, the synchronous generator may be connected to a grid to measure the corresponding under-load time difference T_{UL} and, based on that measurement, calculate θ_{UL}. The calculation of θ_{UL}, based on the measured under-load time difference can be according to Equation (3) below:

θ_{UL}=T_{UL}/T×360 Equation (3)

where T_{UL} time difference between the rotor position pulse 214 and zero-cross of terminal voltage under load 220. It should be noted that under a load condition, the OuL may no longer be constant. This can be due, for example, to the reactive power and the active power of the generator and the power delivered to the grid. In an example implementation, the load angle δ can be determined by applying calculations, for example, according either of the following Equations (4) and (5) to the calculated values of θ_{UL} and θ_{NL}:

δ=θ_{UL}−θ_{NL} Equation (4)

or

δ=(T_{UL}/T×360)−θ_{NL} Equation (5)

It will be understood that, in the above equations, the parameters are measured in angle and not in the time difference.

FIG. 3 illustrates a block diagram of an example implementation of a load angle measurement system 300 providing for one or more processes and methods of the present disclosure. In some implementations, the measurement system 300 may include: a sensor 310, an isolated sensor interface 312, a terminal voltage signal (PT) 314, an isolated zero cross detection unit 316, a processor 318, a display 320, a storage unit 322, a digital/analog card (D/A card) 324, and a data recorder 326. In other implementations, additional components can be included, such as a control panel, a power supply unit, or other components.

In one or more implementations, the sensor 310 may be configured to send a sensor pulse to the processor 318, for example, through an isolated sensor interface 312. A second signal may be received at the processor 318 from the terminal voltage (PT) 314 and through an isolated zero cross detection unit 316. The processor 318 may be configured to calculate θ_{UL} and θ_{NL} and to apply calculations, for example, according to Equation (4) to calculate the load angle δ. In some cases, a display 320 may be used to display the calculated values. The calculated and measured values described above may be stored, for example, in the storage unit 322. In one implementation, a D/A card 324 may be coupled to a data recorder 326 to convert analog data to digital data and vice versa.

Implementations of the processor 318 can include, for example, a DSPIC33FJ256 processor. Implementations of the storage unit 322 can include an SD/MMC card. Implementations of the sensor 310 can include an optical sensor. The sensor 310 may be installed, for example, on the rotor shaft by putting the generator in turning gear. This enables installation of the sensor 310 because, in turning gear, a rotational speed of the rotor can be, for example, approximately 60 rpm. An index marking on the rotor can be provide by attaching a label on the rotor and spraying the index with a dark color. The dark color may then be used by the sensor 310 as the measuring point.

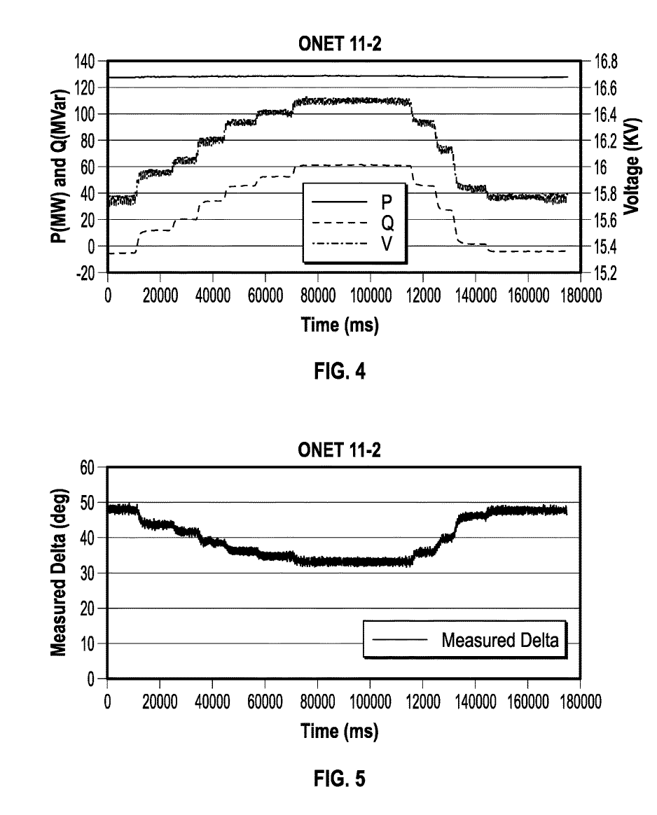

FIG. 4 illustrates calculated values of active power (P), reactive power (Q) and voltage (V) from measurements provided by processes as described above, on implementations of systems in accordance with the description above. Referring to FIG. 4, applying operations and systems configurations as described, measurements results identified a primary active power (P) being approximately 131.3 MW, a primary reactive power being 0 MVar, a primary voltage of 15.79 kV, a primary load angle of 48 degrees, a secondary active power of 131.3 MW, a secondary reactive power of 60.8 MVar, a secondary voltage 16.54 kV and secondary load angle 33.1 degrees. The following equations were used for estimation of the load angle δ:

$$δ = {tan}^{- 1} ( \frac{( {X}_{q} + {X}_{e} ) I cos φ - {R}_{a} I sin φ}{{V}_{t} + {R}_{a} I cos φ + ( {X}_{q} + {X}_{e} ) I sin φ} ) \qquad Equation ( 6 )$$

where

Vₜ represents the terminal voltage;

I represents armature current;

X_{q} represents the quadrature axis synchronous reactance;

Xₑ reactance of the transformer and transmission line;

φ represents the power factor of the load;

Rₐ represents stator winding resistance; and

δ represents the load angle.

It can be assumed, for purposes of this description, that Rₐ is negligible. Equation (6) then becomes:

$$δ = {tan}^{- 1} ( \frac{( {X}_{q} + {X}_{e} ) I cos φ}{Vt + ( {X}_{q} + {X}_{e} ) I sin φ} ) \qquad Equation ( 7 )$$

Implementations are not limited to applications where Ra is negligible. A persons of ordinary skill in the related arts, having possession of the present disclosure and facing such an application, can readily adapt this disclosure to practices, according to its methods, systems, and aspects thereof, on that application.

Referring to Equation (7), multiplying the numerator and divisor by (X_{q}+Xₑ), and multiplying the resulting numerator and divisor by Vₜ yields Equation (8) as follows

$$δ = {tan}^{- 1} ( \frac{P}{[ {V}_{t}^{2} / ( {X}_{q} + {X}_{e} ) ] + Q} ) \qquad Equation ( 8 )$$

where

P represents the active power, and

Q represents the reactive power.

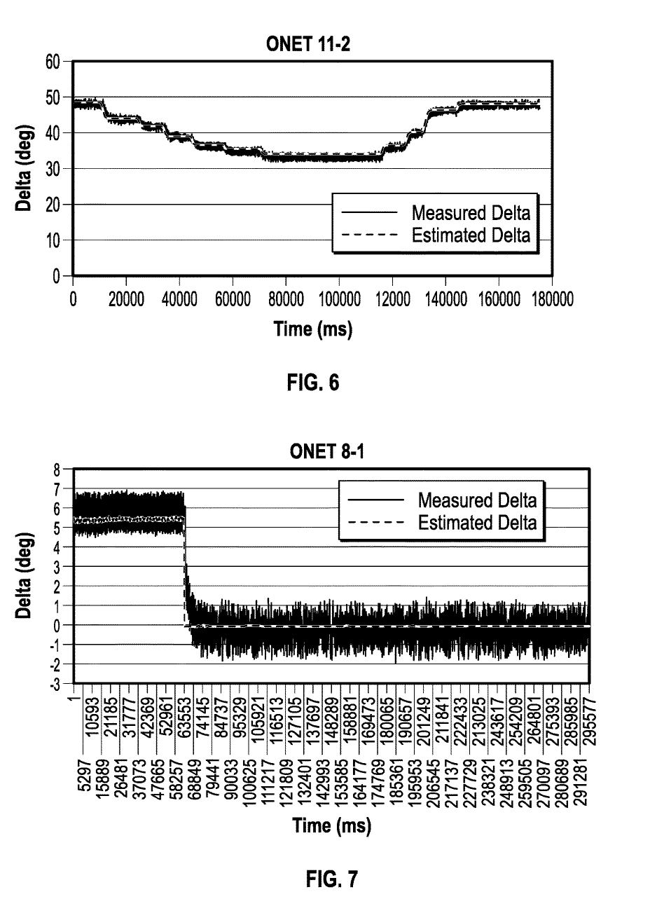

FIG. 5 illustrates results of measured load angle of an example operating synchronous generator, over a time span, in milliseconds, from “0” to “180000,” using measurement and calculation methods and systems described above, in reference to appended figures. The measurement were conducted with the synchronous generator feeding a changing load. FIGS. 6-9 show example comparisons of measurements of load angles at operating synchronous generators using, for example, Equations (6), (7) or (8), over a range of different changing loads, against estimation of load angle, using systems and methods, such as calculations according to Equations (4) or (5), according to this disclosure. As will be appreciated by persons of ordinary skill, the results show good agreement of the calculated load angle provided by the present systems and methods to estimated load angles. It will be understood that exciter currents can be readily controlled using the load angles provided, responsively and rapidly, by the present systems and methods. The present systems and methods thereby provide a practical, low cost technical solution to the above-described technical problem of under-response exciter current control.

FIG. 6 illustrates results of estimation of load angle, and accompanying measurement of load angle, in an example operating synchronous generator, feeding an actual grid, over the timeline (in milliseconds) represented by the FIG. 6 horizontal axis, for purposes of testing example systems and methods, and aspects thereof, according to the present disclosure. In an implementation, estimation included calculations according to Equations (9) and (10):

$${X}_{q} + {X}_{e} = \frac{{V}_{t}^{2}}{P cot δ - Q} \qquad Equation ( 9 )$$

Conditions at t₀=0 for the FIG. 6 testing, for the generator and its output were:
V=15.78229 kV
P=127.393955 MW
Q=−5.1396828 MVar
δ=48.4308 degree=0.845276919 rad

Applying Equation (9) to the above values yielded:

X_{q}+Xₑ=2.108657

The load angle was estimated, as δ_{E}, by applying Equation (10) below to the calculated values of X_{q} and Xₑ.

$${δ}_{E} = {tan}^{- 1} ( \frac{P}{\frac{{V}^{2}}{2.108657} + Q} ) \qquad Equation ( 10 )$$

Referring to FIG. 6, the estimated δ_{E}, load angle shows good agreement with the Equation (8) calculated load angle.

FIG. 7 illustrates a comparison of estimated load angle to measured load angle for a synchronous generator, over time span from time (in milliseconds) “5297” to time “296577” using estimations and measurements provided by the above-described systems and methods, and aspects thereof, according to the present disclosure. Test events included a given load over the time span from time “5297” to “63553,” and a shorting at “63553.”

Referring to FIG. 7, the short at 635553 occurred at an active power 11 MW and reactive power 1 MVar and prior to the short the averaged measured load angle was 5.3 degrees. As illustrated in FIG. 7, the test showed good agreement between the estimated load angle δ_{E} and measured load angle.

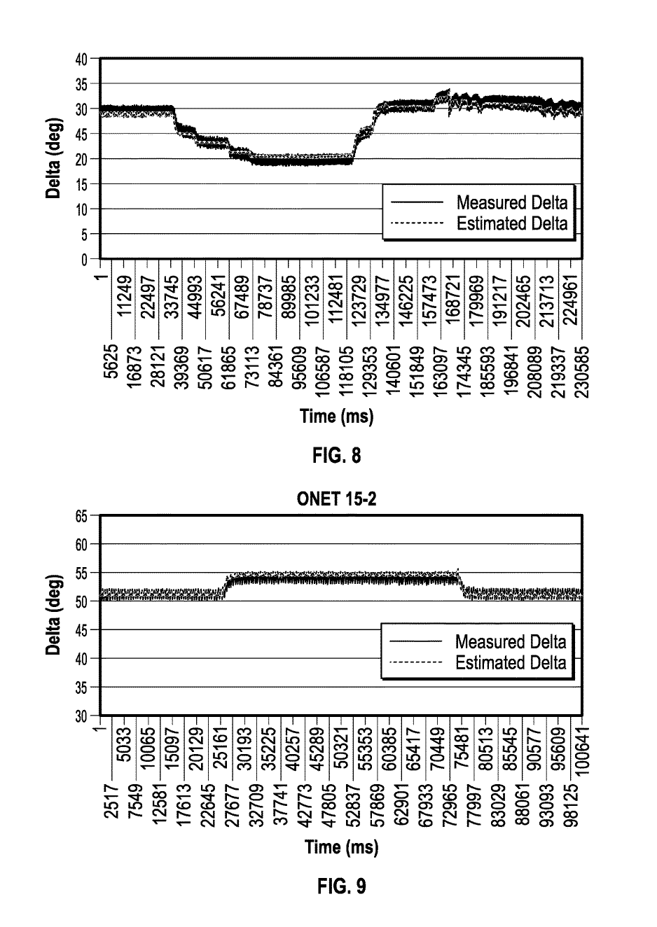

FIG. 8 illustrates a comparison of estimated load angle to measured load angle for a synchronous generator, in response to changing loads, over time span from time “1” to time “296577” using estimation and measurements techniques provided by the above-described systems and methods, and aspects thereof The example load variations caused reference voltage difference from 15.75 kV to 16.53 kV and active power 66.4 MW and reactive power 53.18 MVar. As illustrated in FIG. 8, this test again showed good agreement between the estimated load angle δ_{E} and measured load angle.

FIG. 9 illustrates a comparison of estimated load angle to measured load angle for a synchronous generator, in response to changing loads, over time span from time “1” to time “100641” Also, the results of ONET15-2 test with the tap changing transformer difference from 17 to 16, primary active power 132 MW, primary reactive power 14 MVar, primary voltage 15.77 kV, load angle 54.8 degrees, secondary active power 132, secondary reactive power 27 MVar, secondary voltage 15.77 kV and secondary load angle 51.5 degrees are shown in FIG. 9. All the results show excellent agreement with the calculated values.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A method for load angle measurement comprising:
measuring a position of a rotor under no load and obtaining a resulting measured Difference time between Rotor position and terminal voltage zero-cross under no load;
calculating, at the processor, a no load angle of difference, the no load angle of difference being an angle of difference between where a terminal voltage of a synchronous generator crosses a zero-point and the measured r position of the rotor under no load;
measuring a position of the rotor under load and obtaining a resulting measured difference time between Rotor position and terminal voltage zero-cross under load;
providing to the processor the measured time difference to calculate the under load difference angle; and
calculating the load angle of the synchronous generator based on the measured no load and under load difference angle.

2. The method of claim 1, further comprising:
calculating, at the processor, a load angle of difference, the load angle of difference being an angle of difference between where a terminal voltage of a synchronous generator crosses a zero-point and the measured position of the rotor, when the rotor is under load, wherein
calculating the load angle of the synchronous generator is based on no load angle of difference and the load angle of difference.

3. The method of claim 2, wherein calculating the load angle of the synchronous generator includes subtracting the no load angle of difference from the load angle of difference.

4. The method of claim 1, wherein
calculating the load angle of the synchronous generator is based on calculations according to the equation
δ=(T_{UL}/T×360)−θ_{NL},
where
θ_{NL} is the no load angle of difference,
T_{UL} is the time difference between rotor position and zero cross of the terminal voltage under load,
T is the measured rotor period, and
δ is the load angle.

5. The method of claim 1, wherein
measuring a position of a rotor under no load is performed at a sensor,

6. The method of claim 1, wherein measuring a rotation period of a rotor under no load includes measuring, at a sensor, time intervals for a marked point on the rotor under no load to pass across the sensor.

7. The system of claim 6, wherein:
the point is an optically marked point; and
the sensor includes an optical sensor.

8. The method of claim 1, wherein measuring the load angle difference includes measuring: at a sensor, time intervals for a point on the rotor under load to pass across the sensor.

9. The system of claim 8, wherein:
the point is an optically marked point; and
the sensor includes an optical sensor.

10. The system of claim 1, wherein the processor includes a DSPIC33FJ256 microprocessor.
